(19) United States
(12) Patent Application Publication
(10) Pub. No.: US 2014/0115715 A1
(43) Pub. Date: Apr. 24, 2014

(54) SYSTEM AND METHOD FOR CONTROLLING, OBFUSCATING AND ANONYMIZING DATA AND SERVICES WHEN USING PROVIDER SERVICES

(71) Applicant: Babak PASDAR, (US)

(72) Inventor: Babak Pasdar, Jersey City, NJ (US)

(21) Appl. No.: 13/828,296

(22) Filed: Mar. 14, 2013

Related U.S. Application Data
(60) Provisional application No. 61/717,425, filed on Oct. 23, 2012.

(51) Int. Cl. G06F 21/62

(52) U.S. Cl. CPC G06F 21/6245; G06F 21/6254
USPC 726/26

(57) ABSTRACT

A system, method, and computer readable medium for preventing data leakage from a transmission unit to a service provider (SP), utilizing a network system including a computer, a processor, memory, and a computer readable medium storing thereon computer code which when executed by the at least one computer causes the at least one computer to at least: identify identification information of a user included in data communication between the transmission unit and the SP; identify a SP application via an application signature; determine whether the identified SP application meets at least one data leakage prevention policy for a user; and perform at least one of a plurality of data leakage prevention processes on the transmission unit.

### CROSS REFERENCE TO RELATED APPLICATIONS

This application claims priority to U.S. Provisional Patent Application Ser. No. 61/717,425, the entirety of which is incorporated by reference herein.

### FIELD

The present application relates to the field of computer security and privacy.

### DESCRIPTION OF RELATED ART

Network users utilize a variety of free and paid services delivered by Service Providers (“SP”). SPs provide a wide range of services such as Search Engine, online-shopping or social platforms. Non-limiting examples of these SPs include Google, Amazon, FaceBook, Microsoft, and Yahoo, who provide services such as search functionalities, Domain Name Services (“DNS”), Phone, Voicemail, Map, Groupware (email, task-list; contacts, and Calendaring), and office-related functionalities (Word-processing, Spreadsheet, Presentation, and Database).

By leveraging the services provided to a user, SPs may also identify, categorize, profile and track users for their identity, associations, usage patterns, behavior and or content with or without the user's awareness. For example, U.S. Pat. Pub. No. 2012/0072284, the entirety of which is incorporated by reference herein, describes a method, system., and apparatus for generating user identifier profiles. In another example, U.S. Pat. No. 8,185,561, the entirety of which is incorporated b reference herein, is directed to methods and apparatus, for providing clustering of users, the entirety of which is incorporated herein by reference.

Generally speaking, a necessary step of SPs to track a user is to identify a user via overt methods such as registration to use a service or covert methods such as using information transmitted by a user or collected from the user's system (s). A single piece of information about the user may be used by SP to identify the user. For example, an SP may use a user's account number to track a usage history. An SP may also use a cookie, which is a data file saved on a user's computer to track a user. The SP may also use the source user's IP address to track a user. In addition to create an identifier by a single piece of information, SPs may combine a plurality of pieces of user's information to identify a user. For example, SP may use a user's IP address as well as port number, and the user's profile through browser cookies or other means of unique identification of user communications destinations, content, behavior, historical trends, and other metrics.

Although some users offer their consent to SP's tracking and profiling practice in exchange of accessing the service, most users do not discern or comprehend the full consequences of allowing these tracking and profiling practices. For example, a user may have a false sense of privacy and security because he or she joins a virtual community without giving his or her true identity. But, with the aid of intelligent algorithms and massive amounts of online data about users, these tracking and profile practices and tools can accurately determine the true identity of the person or organization associated with an identifier after that person or organization uses the service of a SP for a period of time. It is worth noting that profiles associated with that identifier would reflect the actual interests and activities of chat person and organization most of the time. Such discovery of personal and or private data by a SP represents both a privacy concern with the leakage of private data as well as a computer security risk by virtue of disclosing by content or criteria vulnerabilities, exposures, weaknesses, and or points of entry, all recognized as a system or device's “Attack Surface.”

### SUMMARY

The present application is directed to a system, and method for implementing controls of services provided by third-party providers, obfuscation of data collected in the process of delivering services, and the anonymization of information capable of identifying an originator accessing the services.

The present application discloses a system, apparatus, and method that help to protect an organization, user and or system's privacy and security. The method of connectivity can include any bi-directional communications medium and layer including Layer 2, Layer 3 or combination of Layer 2 and Layer 3 network(s) and could exist over public, private, and or hybrid (public/private) networks. For example the medium could include Internet, Ethernet, wireless networks, public communications network such as phone network, SMS, and or broadcast networks.

Specifically, in an embodiment, the present application anonymizes user-identification information included in a data unit that is capable of identifying the user. The user-identification information can represent any of a plurality of types of identifying information, including addresses, such as MAC and IP port designations, location and or device identifiers), phone number, IC card number, user name and or other designation, and or any other information used by the user or the SP to identify the organization, user, system or device.

According to another embodiment, the present system includes a platform that can operate either physically or virtually between one or more users and or devices and a provider of services including but not limited to applications, functions, and or services the user may utilize either transparently and or consciously either as a free or paid basis.

According to an embodiment, the present system detects unique signatures to identify communications for specific SP applications. These signatures may include a variety of metrics to identify SP applications including: Name Services and source and destination IP address; communications, such as packet size and metadata, packet combinations, unique behavior, network protocol, network source, and or destination port, application protocols, and application specific functions.

According to another embodiment, the present system analyzes the content of communications destined to or received from the SP and identifies any characteristics within those communications that identify, categorize, or track the user and/or leak information by content or criteria about the user, user environment, device, operating platform, application, and or data.

According to another embodiment, the present system replaces the. source address of the user, with an alternate address that does not uniquely identify the user source.

According to another embodiment, the present system replaces the source port number of the user, such as the user's address, with an alternate address not uniquely identifying the user.

According to another embodiment, the present application provides a plurality of control polities to a user. Once the user creates a preference of one or more policies, that policy is applied, according to which the communication can be 1) blocked, 2) redirected to alternate allowed SP(s), 3) anonymized, 4) obfuscated, and/or 5) privatized. The control policies are as follows:
A blockage stops the transmission of that particular communication to a destination.
Redirection or alternation directs that communication to another SP preselected by the user or the system.
Anonymization allows the source address and port number to be masked, thus preventing the source from being identified by cross-referencing and preventing user identification and device state information disclosure.

Obfuscation scans the content to assess the use of unique identifier(s) that can be used for profiling and tracking purposes and either remove or replace these identifiers) with generic alternatives that will obfuscate the original user(s) or source. In the event, a SP application insists on having a per user unique identity, the present system offers a designated per user individual generic unique, identifier that can be assigned to a user.

Privatization allows injection of industry standard or SP specific tag(s) into the communication to inform. SP that the user does not wish to be tracked. Privatization also may strip or block delivery or request for various contents deemed unsafe, unauthorized or unnecessary. The industry standard may include a code or message indicating the user's preference of no tracking or no profiling.

According to another embodiment, the present system intelligently prevents user utilization and traffic from establishing utilization trends by utilizing the generic identifier(s) with self-generated traffic that is one or more of the following:
Random;
By Category;
By Volume; to access a variety of sites and content ranging in category and volume to circumvent any trending of the mass access by users.

According to another embodiment, the system and method as set forth in the present application acts as a middleman between the user and the SP application either physically or virtually and can operate across Layer 1 connection, Layer 2 networks, Layer 3 networks or even across public networks with or without the use of tunneling technologies.

According to another embodiment, should the SP's system policy demand unique identifiers to function, the system can deliver a unique generic identifier and other associated relevant data and functions per each user to maintain SP functionality while retaining user privacy.

According to another embodiment, the system can inject behavioral labels into user communications to ensure that the communication adheres to usage policy or that the SP adheres to a provider specific or industry standard behavior.

### BRIEF DESCRIPTION OF DRAWINGS

FIG. 1 illustrates a Layer 2 address masking process according to an embodiment of the present, disclosure.

FIG. 2 illustrates a Layer 3 address masking process according to an embodiment of the present disclosure.

FIG. 3 illustrates a Network source port number replacing process according to an embodiment of the present disclosure.

FIG. 4 illustrates a proxy model utilized in the present system according to an embodiment of the present disclosure.

FIG. 5 illustrates a content obfuscation process utilized in the present system according to an embodiment of the present disclosure.

FIG. 6 illustrates a content injection process utilized in the present system according to an embodiment of the present disclosure.

FIG. 7 illustrates a content stripping process utilized, in the present system according to an embodiment of the present disclosure.

FIG. 8 illustrates an exemplary structure of a server, system, or a terminal according to an embodiment.

### DETAILED DESCRIPTION OF EMBODIMENTS

It is to be understood that the figures and descriptions of the present embodiments of the invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

Described are embodiments for system, method, and computer readable medium for preventing data leakage from a transmission unit to a service provider (SP), utilizing a network system including a computer, a processor, memory, and a computer readable medium storing thereon computer code which when executed by the at least one computer causes the at least one computer to at least: identify identification information of a user included in data communication between the transmission unit and the SP; identify a SP application via an application signature; determine whether the identified SP application meets at least one data leakage prevention policy for a user; and perform at least one of a plurality of data leakage prevention processes on the transmission unit.

The present system can implement a method for protecting a network user's privacy and security comprising:

identifying a source for a user (e.g. a user's terminal or device);

identifying a SP application via an application signature;

determining if at least one policy allows at least one user to utilize of the SP application and;

implementing a controls on user's use of the SP application that can comprise one or mote of:
blocking the use of the SP application;
redirecting SP application for the user, based on policy to an alternative SP application;
if use of SP application is allowed, to anonymize the users' source addressees) and network protocol port for the specified SP application communication via Address Translation or via Proxy and or;
obfuscating the user's unique identifiers) by deleting or displacing the unique identifier(s) with a generic identifiers) within the specified SP application communication;
obfuscation based on designated per user individual generic unique identifiers for SP applications that requires a unique identifier to function;
obfuscating the communication by injecting behavioral labels into the communications to elicit behaviors such as industry standard or SP specific labels;
privatizing may also strip away, block or reject attempts by SP or SP application or third-party access to deliver functions from, unsafe, unnecessary and or unauthorized alternate sites or content, all-the-while allowing the safe, necessary, timely and or authorized sites or content;
privatization may also strip away, block or reject requests for dangerous, unnecessary or unauthorized information from the user, user system or user device; or
understanding the communication trends for category(s) of content accessed by users and generating compensating communications utilizing a generic unique identifier based on random and or directed category specific traffic to offset, and prevent any trends that may be associated with users traffic and the generic identifier.

The order with which this process occurs may exclude certain components or vary in order depending on a variety of circumstances; however the general process remains valid.

The present system prevents users from accessing unauthorized SPs, SP application(s) as well as preventing SPs from identifying, profiling and tracking users, and user date, by content, criteria, and statistical data that could highlight communications, behavior, habits, moods, relationship(s), association(s), personal data, health data and status, financial data, dealings and status, interests, sexual preferences and or habits, employment, business, business direction, business strategies, challenges and success and more, among the numerous information that could be obtained through the use of SP application.

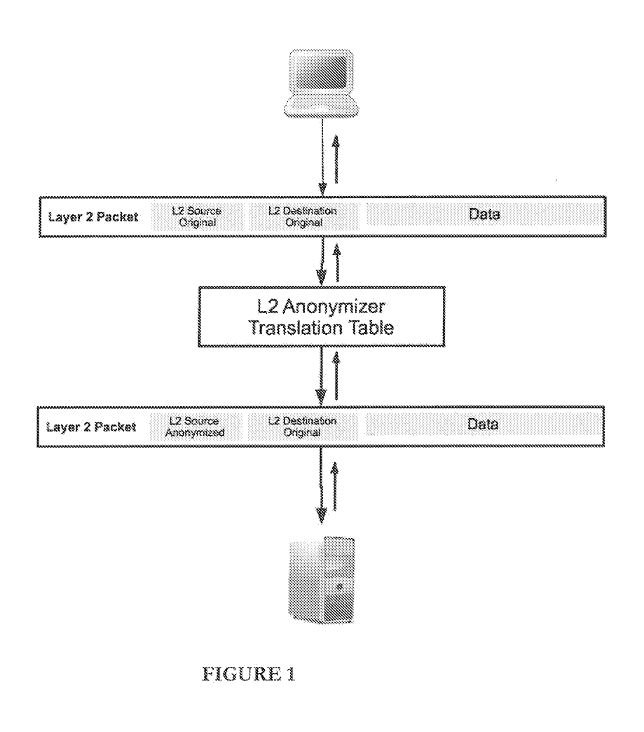

FIG. 1 shows an embodiment of a Layer 2 address masking process. As shown in FIG. 1, an anonymization process could include either address translation of user Layer 2 source address. For example, the Layer 2 source address could be replaced and the packet forwarded to the destination. The response traffic from the destination is then received and the anonymized address is replaced with the original Layer 2 address and the packet forwarded. This process can simultaneously support numerous disparate Layer 2 sources and is transparent to the source user and or device as well as the destination user and or device. According to an embodiment, the present system creates a table or a storage space for associating the original Layer 2 address with the anonymized address. The user's device in FIG. 1 may be, for example and without limitation thereto, a computer, a smart phone, a tablet, e-reader, or a laptop.

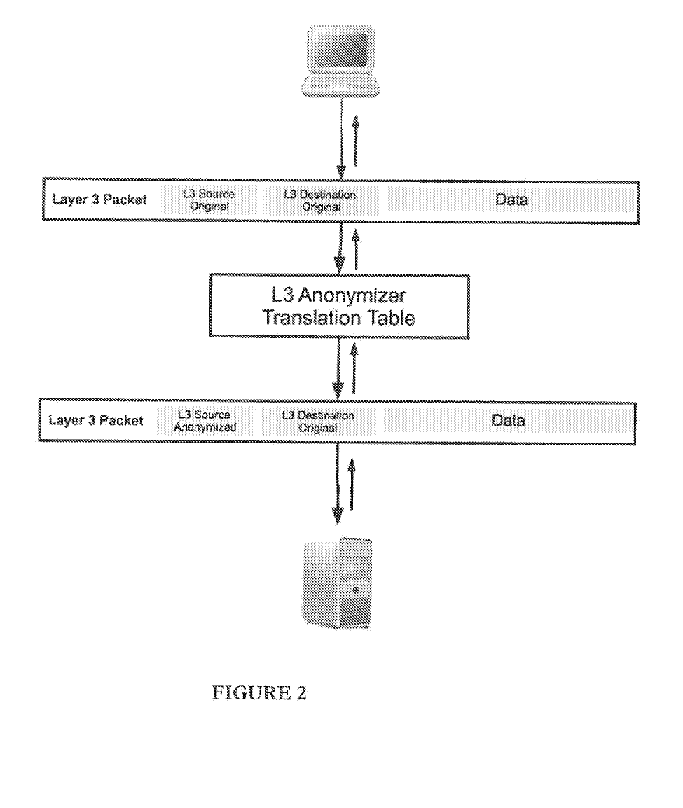

FIG. 2 shows an embodiment of a Layer 3 address masking process. As shown in FIG. 2, the Layer 3 source address could be replaced by our system and the packet forwarded to the destination. The response traffic from the destination is then received and anonymized address is then replaced with the original Layer 3 address and the packet forwarded. This process is transparent to the source and destination user and/or device.

Conversely, as an embodiment of a Layer 3 address masking process, the destination address could be masked or replaced so as to anonymize the destination. Accordingly, in various embodiments, both source and destination Layer 3 address translation may be utilized simultaneously.

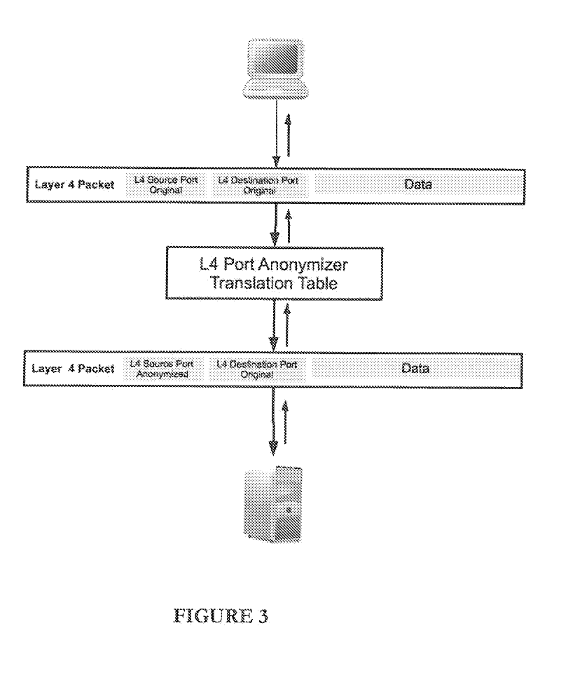

According to an embodiment as shown in FIG. 3, the present system also replaces Network source port number and then forwards the packet to the destination. The response traffic from the destination is then received and anonymized port number is then replaced with the original port number and the packet forwarded. This process is transparent to the source user and or device.

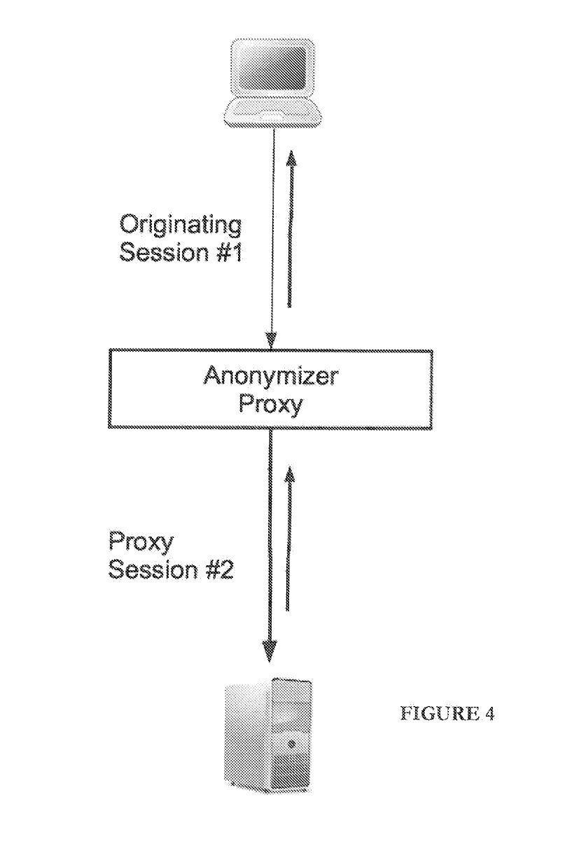

According to an embodiment, FIG. 4 shows a proxy model used by the system. As shown in FIG. 4, the anonymization process utilizes a Proxy model where user or device communications is terminated to the Proxy system and the Proxy in-turn initiates communications to the original intended destination with the user's original communications. The response from destination is then repackaged at the proxy and re-directed to the user or device. Since the communications is terminated at the Proxy and re-established to the destination, the originating user or device source address and port number are masked by that of the Proxy system. This process may be transparent to the source user or device or a Proxy may be specified on the function on the device.

According to an embodiment, the system leverages Application Signature(s) that are unique signatures to identify communications for specific SP applications. These signatures may leverage a variety of metrics to identify SP applications including: Name Services and source and destination IP address; communications, such as packet size and metadata, packet combinations, unique behavior, network protocol network source and or destination port, application protocols, and application specific functions.

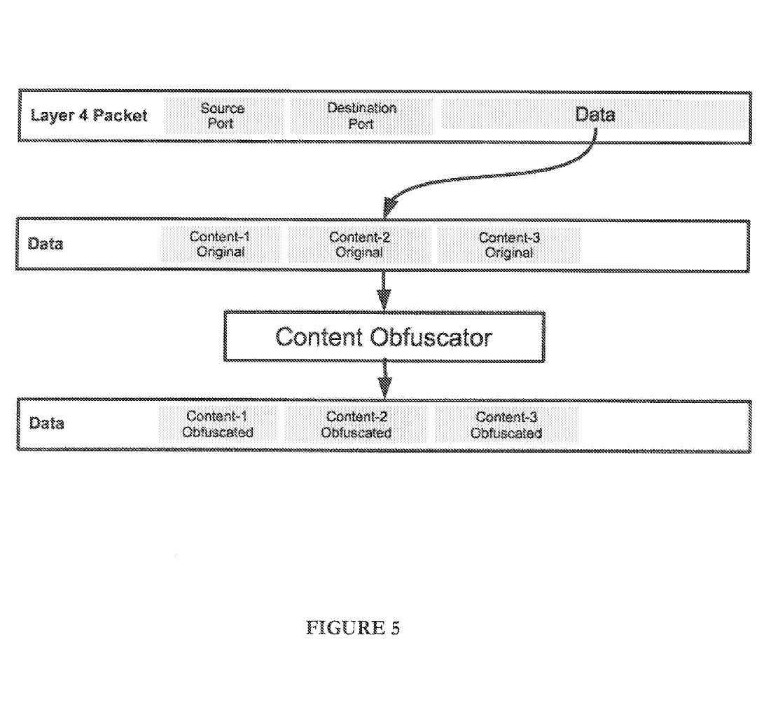

According to an embodiment, FIG. 5 shows content obfuscation used by the system. As shown in FIG. 5, the system can obfuscate content by identifying SP specific identifiers and by employing a content obfuscator component configured to replace the specific identifiers with either a generic or unique identifier.

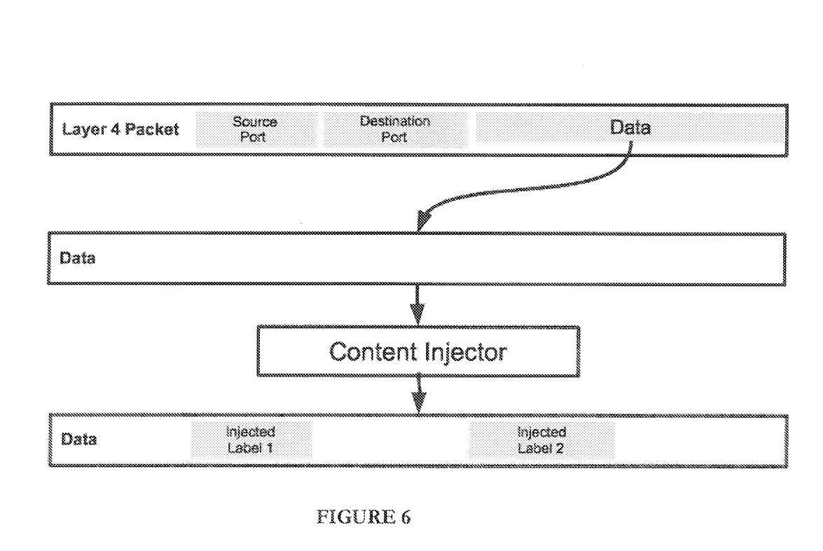

According to an embodiment, FIG. 6 shows content injection used by the System. The System can impact the SP application with a content injector component configured to insert a SP specific or industry standard label to impact behavioral changes at the source, destination or both. Such industry standard label may indicate that a user has an increased privacy preference, a user does not wane any tracking or profiling by the SP, or a user does not want the SP to even store his or her history information.

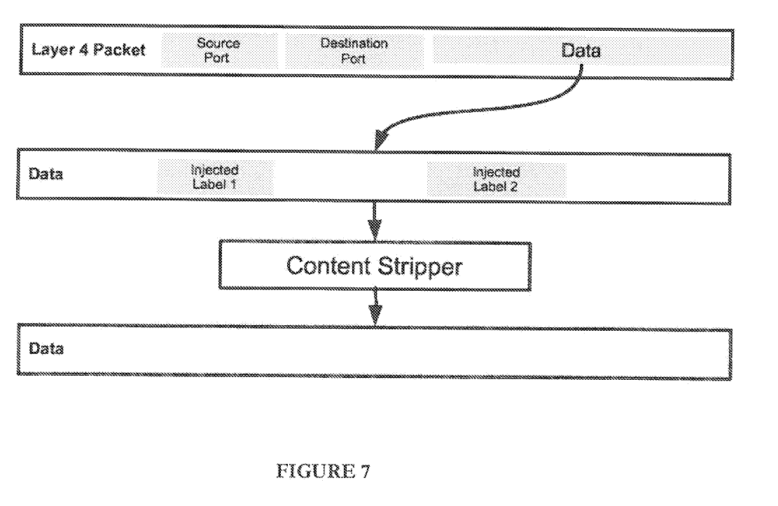

According to an embodiment, FIG. 7 shows content stripping used by the System. As shown in FIG. 7, the System can impact the SP application by employing a content stripper component configured to strip away, block or reject SP specific or industry standard labels to impact behavioral changes at the source, destination or both. Furthermore, the content stripping system may analyze the content and strip away, block or reject communications deemed malicious, dangerous or otherwise do not meet policy standards.

According to an embodiment/search engines, by virtue of their tracking of user's unique identifiers such as originating address and other unique identifiers embedded in the data communications such as cookies among other standard or customized mechanisms, can build profiles on users and track them on an ongoing basis. Moreover, this information is retained by the Search Engine SP to deliver skewed results that is based on the Search Engine Provider's categorization of the user. This is referred to as a “Filter Bubble.” The present system prevents the above by any one or more or all of:
replacing the user source address(es);
replacing any unique identifier that represents each user with one or more generic identifiers that anonymizes the user;
injecting industry standard or SP application specific behavioral codes such as do not track;
stripping off unsafe, unauthorized, or unnecessary communications, or
blocking access to user, user system, user device for unauthorized and unnecessary information.

Another example is that while utilizing a SP application such as a Search Engine, the user's immediate query is shared with one or more other organizations that then 1) delivers targeted advertisements to the user directly and 2) plants cookies and or other unique identifiers on the user device. This content may be delivered on the same page as the SP application or via a new page or both. And may leverage one or multiple sessions initiated from the SP network or other third-party. The present system prevents the above by any one or more or all of:
replacing the user source address(es)
replacing any unique identifier that represents each user with one or more generic identifiers that anonymizes the user
injecting industry standard or SP application specific behavioral codes such as do not track,
stripping off unsafe, unauthorized, or unnecessary communications from the original SP application and site as well as the that of the other organizations.
blocking access to user, user system, user device for unauthorized and unnecessary information for the original SP application and site as well as the other organizations.

Another example is when a SP that tracks the user while using SP application, implements a system that continues to track the user even after the user has logged out of the SP application and or site. The present system, prevents the above by any one or more or all of:
replacing the user source address(es)
allowing the use of unique identifiers as may be required by the application for proper functionality
injecting industry standard or SP application specific behavioral codes.
allowing user to control if the SP application can track user activity as may be required to achieve application functionality while the application is in use and prevent the SP application from tracking the user when application is not in use.
blocking access to user, user system, user device for unauthorized and unnecessary information for the original SP application.,

Another example includes a “Do Not Track” option which informs advertisers and sites that the user does not wish to be tracked. Even if not supported by the user system or device, should the user policy specify this, the present system is configured with a content injection component to inject this option into the communication stream.

Another example, is a SP that requires unique identifier for each individual user to function. This could include, for example a free or paid email service. In an embodiment the system is configured to generate an alternate generic unique identifier for the user that can be be used each time the user utilizes the service. The system will replace or inject other unique identifiers with the generic identifier that it acquires on behalf of the user and thus prevents the service from identifying the user.

As used herein, a network should be broadly construed to include any one or more of a number of types of networks that may be created between, devices using an internet connection, a LAN/WAN connection, a telephone connection, a wireless connection and so forth. Each of the terminals, servers, and systems may be, for example, a server computer or a client computer or client device operatively connected to network, via bi-directional communication channel, or interconnector, respectively. A connection/coupling may or may not involve additional transmission media, or components, and may be within a single module or device or between the remote modules or devices.

It should be appreciated that a typical system can include a large number of connected computers (e.g., including server clusters), with each different computer potentially being at a different physical or virtual node of the network. The network, and intervening nodes, may comprise various configurations and protocols including the internet, World Wide Web, intranets, virtual private networks, wide area networks, local networks, private networks using communication protocols proprietary to one or more companies, Ethernet, WiFi and HTTP, cloud and cloud based services, and various combinations of the foregoing. Such communication may be facilitated by any device capable of transmitting data to and from other computers, such as modems (e.g., dial-up, cable or fiber optic) and wireless interfaces.

The terminals, servers, devices, and systems are adapted to transmit data to, and receive data from, each other via the network. The terminals, servers, and systems typically utilize a network SP, such as an Internet SP (ISP) or Application SP (ASP) to access resources of the network.

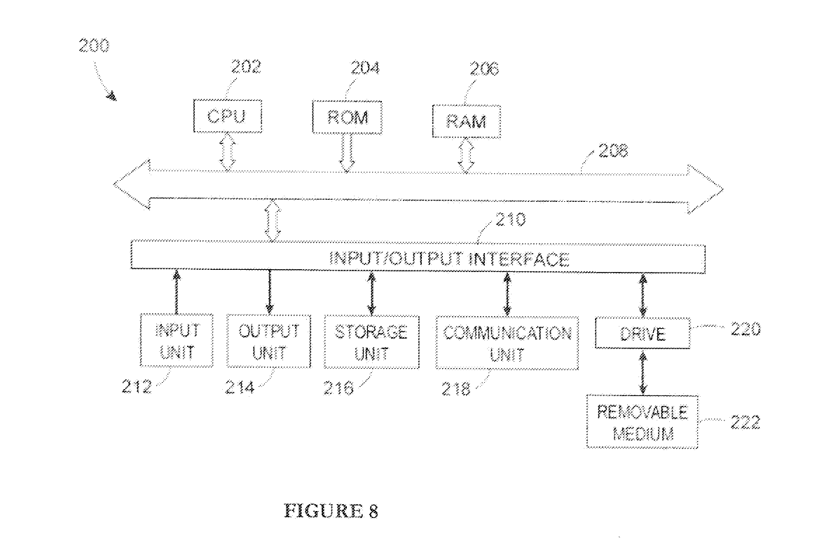

FIG. 8 illustrates an exemplary structure of a server, system, or a terminal according to an embodiment.

The exemplary server, system, or terminal 200 includes a CPU 202, a ROM 204, a RAM 206, a bus 208, an input/output interface 210, an input unit 212, an output unit 214, a storage unit 216, a communication unit 218, and a drive 220. The CPU 202, the ROM 204, and the RAM 206 are interconnected to one another via the bus 208, and the input/output interface 210 is also connected to the bus 208. In addition to the bus 208, the input unit 212, the output unit 214, the storage unit 216, the communication unit 218, and the drive 220 are connected to the input/output interface 210.

The CPU 202, such as an Intel Core™ or Xeon™ series microprocessor or a Freescale™ PowerPC™ microprocessor, executes various kinds of processing in accordance with a program stored in the ROM 204 or in accordance with a program loaded into the RAM 206 from the storage unit 216 via the input/output interface 210 and the bus 208. The ROM 204 has stored therein a program to be executed by the CPU 202. The RAM 206 stores as appropriate a program to be executed by the CPU 202, and data necessary for the CPU 202 to execute various kinds of processing.

A program may include any set of instructions to be executed directly (such as machine code) or indirectly (such as scripts) by the processor. In that regard, the terms “instructions,” “steps” and “programs” may be used interchangeably herein. The instructions may be stored in object code format for direct processing by the processor, or in any other computer language including scripts or collections of independent, source code modules that are interpreted on demand or compiled in advance. Functions, methods and routines of the instructions are explained in more detail below.

The input unit 212 includes a keyboard, a mouse, a microphone, a touch screen, and the like. When the input unit 212 is operated by the user, the input unit 212 supplies an input signal based on the operation to the CPU 202 via the input/output interface 210 and the bus 208. The output unit 214 includes a display, such as an LCD, or a touch screen or a speaker, and the like. The storage unit 216 includes a hard disk, a flash memory, and the like, and stores a program executed by the CPU 202, data transmitted to the terminal 200 via a network, and the like.

A removable medium 222 formed of a magnetic disk, an optical disc, a magneto-optical disc, flash or EEPRGM, SDSC (standard-capacity) card (SD card), or a semiconductor memory is loaded as appropriate into the drive 220. The drive 220 reads data recorded on the removable medium 222 or records predetermined data on the removable medium 222.

One skilled in the art will recognize that, although the data storage unit 216, ROM 204, RAM 206 are depicted as different units, they can be parts of the same unit or units, and that the functions of one can be shared in whole or in part by the other, e.g., as RAM disks, virtual memory, etc. It will also be appreciated that any particular computer may have multiple components of a given type, e.g., CPU 202, Input unit 212, communications unit 218, etc.

An operating system such as Microsoft Windows 7®, Windows XP® or Vista™, Linux®, Mac OS®, or Unix® may be used by the terminal. Other programs may be stored instead of or in addition to the operating system. It will be appreciated that a computer system may also be implemented on platforms and operating systems other than, those mentioned. Any operating system or other program, or any part of either, may be written using one or more programming languages such as, e.g., Java®, C, C++, C#, Visual Basic®, VB.NET®, Perl, Ruby, Python, or other programming languages, possibly using object oriented design and/or coding techniques.

Data may be retrieved, stored or modified in accordance with the instructions. For instance, although the system and method is not limited by any particular data structure, the data may be stored in computer registers, in a relational database as a table having a plurality of different fields and records, XML documents, flat files, etc. The data may also be formatted in any computer-readable format such as, but not limited to, binary values, ASCII or Unicode. The textual data might also be compressed, encrypted, or both. By further way of example only, image data may be stored as bitmaps comprised of pixels that are stored in compressed or uncompressed, or lossless or lossy formats (e.g., JPEG), vector-based formats (e.g., SVG) or computer instructions for drawing graphics. Moreover, the data may comprise any information sufficient to identify the relevant information, such as numbers, descriptive text, proprietary codes, pointers, references to data stored in other memories (including other network locations) or information that is used by a function to calculate the relevant data.

It will be understood by those of ordinary skill in the art that the processor and memory may actually comprise multiple processors and memories that may or may not be stored within the same physical housing. For example, some of the instructions and data may be stored on removable memory such as a magneto-optical disk or SD card and others within a read-only computer chip. Some or all of the instructions and data may be stored in a location physically remote from, yet still accessible by, the processor. Similarly, the processor may actually comprise a collection of processors which may or may not operate in parallel. As will be recognized by those skilled in the relevant art, the terms “system, ” “terminal,” and “server” are used herein to describe a computer's function in a particular context. A terminal may, for example, be a computer that one or more users work with directly, e.g., through a keyboard and monitor directly coupled to the computer system. Terminals may also include a smart phone device, a personal digital assistant (PDA), thin client, or any electronic device that is able to connect to the network and has some software and computing capabilities such that it can interact with the system. A computer system or terminal that requests a service through a network is often referred to as a client, and a computer system or terminal that provides a service is often referred to as a server. A server may provide contents, content sharing, social networking, storage, search, or data mining services to another computer system or terminal. However, any particular computing device may be indistinguishable in its hardware, configuration, operating system, and/or other software from a client, server, or both. The terms “client” and “server” may describe programs and running processes instead of or in addition to their application to computer systems described above. Generally, a (software) client may consume information and/or computational services provided by a (software) server or transmitted between a plurality of processing devices.

As used in tins application, the terms “component” or “system” is intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Systems and methods described herein may by implemented by software, firmware, hardware, or any combination(s) of software, firmware, or hardware suitable for the purposes described herein. Software and other modules may reside on servers, workstations, personal computers, computerized tablets, PDAs, and other devices suitable for the purposes described herein. Software and other modules may be accessible via local memory, via a network, via a browser of other application in an ASP context, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, command line interfaces, and other interfaces suitable for the purposes described herein. Except to the extent necessary or inherent in the processes themselves, no particular order to steps or stages of methods or processes described in this disclosure, including the , is implied. In many cases the order of process steps may be varied, and various illustrative steps may be combined, altered, or omitted, without changing the purpose, effect or import of the methods described.

It will be appreciated by those ordinarily skilled in the art that the foregoing brief description and the following detailed description are exemplary (i.e., illustrative) and explanatory of the subject matter as set forth in the present disclosure, but are not intended to be restrictive thereof or limiting of the advantages that can be achieved by the present disclosure in various implementations. Additionally, it is understood that the foregoing summary and ensuing detailed description are representative of some embodiments as set forth in the present disclosure, and are neither representative nor inclusive of all subject matter and embodiments within the scope as set forth in the present disclosure. Thus, the accompanying drawings, referred to herein and constituting a part hereof, illustrate embodiments of this disclosure, and, together with the detailed description, serve to explain principles of embodiments as set forth in the present disclosure.

1. A system for preventing data leakage from a transmission unit to a service provider (SP) comprising a computer, a processor, and memory, and a computer readable medium storing thereon computer code which when executed by the at least one computer causes the at least one computer to at least:
identify identification information of a user included in data communication between the transmission unit and the SP; and
identify a SP application via an application signature;
determine whether the identified SP application meets at least one data leakage prevention policy for a user;
perform at least one of a plurality of data leakage prevention processes of the transmission unit.

2. The system of claim 1,
wherein the identification information of the user includes a transport layer address, network layer address and network source address.

3. The system of claim 1, wherein the at least one data leakage prevention process comprises;
blocking the data communication to the predetermined SP.

4. The system of claim 1, wherein the at least one data leakage prevention process comprises:
redirecting the data communication to an alternate SP.

5. The system of claim 1, wherein the at least one data leakage, prevention process comprises:
anonymizing the identification information which is used by the SP to track the user.

6. The system of claim 5, wherein the anonymizing of the identification information comprises:
replacing the transport layer address and the network layer address with anonymized addresses.

7. The system of claim 5, wherein the anonymizing of the identification information comprises:
replacing the network source address with anonymized port number.

8. The system of claim 5, wherein the anonymizing of the identification information comprises:
terminating an original data communication between the transmission unit and the SP at a Proxy, and
re-establishing data communication between the Proxy and the SP according to the original data communication.

9. The system of claim 1, wherein the at least one data leakage prevention process comprises
obfuscating content of data communication between the transmission unit and the SP by identifying SP specific identifiers and replacing the SP specific identifiers with generic identifiers or unique identifiers.

10. The system of claim 9, wherein the SP specific identifiers indicate a plurality of parameters of the data communication between the transmission unit and the SP.

11. The system of claim 1, wherein the at least one data leakage prevention process comprises:
injecting behavioral labels into the data communication between the transmission unit and the SP for preventing the SP from profiling or tracking the user.

12. The system of claim 11, wherein the behavioral labels include one or more SP specific labels and industry standard labels.

13. The system of claim 1, wherein the at least one data leakage prevention process comprises:
stripping away the behavioral labels from the data communication between the transmission unit and the SP.

14. A method for preventing data leakage from a transmission unit to a service provider (SP), utilizing a network system including a computer, a processor, memory, and a computer readable medium storing thereon computer code which when executed by the at least one computer causes the at least one computer to at least:
identity identification information of a user included in data communication between the transmission unit and the SP; and
identify a SP application via an application signature;
determine whether the identified SP application meets at least one data leakage prevention policy for a user; and
perform at least one of a plurality of data leakage prevention processes on the transmission unit.

15. A non-transitory computer-readable recording medium for storing a computer program including program instructions that, when executed on a computer comprising a processor and memory, performs the method comprising:
identifying identification information of a user included in data communication between the transmission unit and the SP; and
identifying a SP application via an application signature;
determining whether the identified SP application meets at least one data leakage prevention policy for a user; and
performing at least one of a plurality of data leakage prevention processes on the transmission unit.
